(19) United States
(12) Patent Application Publication
(10) Pub. No.: US 2011/0200388 A1
(43) Pub. Date: Aug. 18, 2011

(54) Anti-Theft Device for Removeable Manhole and Gully Covers

(76) Inventor: Omar A. Buhamad, (US)

(21) Appl. No.: 12/706,858

(22) Filed: Feb. 17, 2010

(51) Int. Cl. E02D 29/14; E05B 65/00

(52) U.S. Cl. 404/25; 70/167

(57) ABSTRACT

An anti-theft device for a removable manhole covers or the includes a fixed iron frame that is embedded in a mass of concrete surrounding the manhole and a removable iron gully cover having an outer rim and a plurality of parallel cross members that define a plurality of openings in the cover. The fixed iron frame and removable gully cover each have a generally rectangular shape and the cover is constructed and dimensioned to fit within the frame to close the opening. A pair of shackles and an iron chain are provided to attach the cover to the frame in many manners described which will result in the ability of opening the manhole cover with the prevention of the removal of the cover from the immediate area.

### FIELD OF THE INVENTION

This invention relates to an anti-theft device for removable manhole, gully and the like covers, and an anti-theft device and more particularly to a removable locking device for giving access to an underground facility and an anti-theft device that allows removal of the cover for access to the underground facility while preventing removal of the cover from the immediate area.

### BACKGROUND FOR THE INVENTION

Manhole covers, sewer grids and the like are typically located along paved roadways and constructed of cast iron with parallel spaced bars in a grid pattern with openings there between. Typical installations include an iron frame embedded in the concrete pavement. Manhole covers and drain covers typically weigh about 150 lbs. or more. Nevertheless, manhole covers, drain covers and the like are frequently stolen by thieves or vandals necessitating costly replacement. In addition, the missing covers may cause serious damage to motor vehicles and serious injuries to individuals.

Grate lock devices have locking mechanisms for removeably securing a manhole cover or grate having a plurality of spaced apart grate bars to a frame are well known and have been in use for many years. For example, a U.S. Pat. No. 1,384,712 of Shanley, discloses a manhole cover for catch basins, public utility street-vaults, battery wells for railway signal systems, etc., and has special reference to covers or closures for manholes. The patent discloses a mechanism for locking a cover to the manhole. For example, an ordinary bolt may be screwed into a member and provided with a head of special shape which requires a special wrench to remove it.

A more recent grate lock device is disclosed in a U.S. Pat. No. 4,257,193 of Williams. As disclosed, a device for locking a grate or the like to a frame makes it difficult for the removal of the grate by an unauthorized person. The locking mechanism has a spring loaded latching pin carried by supports secured to the grate. The shoulders provided by either a necked portion of the latching pin or by a flange on the latching pin serve to prevent the unlatching of the latching pin against the biasing of the spring by the use of a makeshift tool. In some embodiments the shoulders are inclined at an angle with respect to the longitudinal axis of the latching pin to encourage the slippage of makeshift tools off from the shoulders to thereby prevent the unlatching of the pin by an unauthorized person using a makeshift tool. In some embodiments, the unlatching hole in the grate is offset from the locking device to prevent the inspection of the locking device by an unauthorized person seeking to discover the manner of operation of the locking device.

A more recent U.S. Pat. No. 5,864,990 of Tu discloses an improved drain board for use on a gutter particularly a cover board pivotally secured to a mounting bracket. The cover board has an outwardly extending pivot pole at one corner thereof and an inwardly extended receiving tube at the opposite corner for accommodation of a bias spring and a movable pivot rod. At the corresponding corners of the mounting bracket is disposed an outwardly extended engaging tube is disposed to permit a fixed pivot pole and a movable pivot rod of the cover board to be pivotally mounted onto the mounting bracket and the cover board is well protected from being stolen with ease by burglars.

A further U.S. Pat. No. 7,201,533 of DeGreef, discloses a sewer grate having a locking mechanism for preventing removal of the grate from its mounting frame by unauthorized persons. The locking mechanism includes a grate hold-down device, a threaded nut attached to the mounting frame below the hold-down device, and a bolt extending downwardly through the hold-down device into threaded engagement with the nut. The head of the bolt is specially constructed so that a specially-formed wrench is required to unscrew the bolt from the nut.

Notwithstanding the above it is presently believed that there is a need and a potential commercial market for an improved manhole cover with an anti-theft device in accordance with the present invention, which makes use of a newly renovated mechanism different from the ones discussed in previous patents. There should be a demand for such devices since the presently disclosed device allows for relatively easy opening of the manhole cover when needed and yet prevents the cover from being removed from the immediate area by vandals. In addition the easy setting of the locking device is believed to be relatively inexpensive and yet securely protects the cover from being removed from the area. The locking device as presently disclosed is also durable which makes it quite difficult for a theft or vandal to carry off the cover. In the meantime, in emergencies, it is quite easy and fast to get access of the manhole.

### BRIEF SUMMARY OF THE INVENTION

An improved anti-theft device for a removable manhole cover or the like and anti-theft device for preventing unauthorized removal of the cover from the immediate area wherein the device includes a fixed iron frame surrounding an opening for access to an underground facility and wherein the fixed iron frame is embedded in concrete which surrounds the opening. A removable iron cover having an outer rim that comes in many shapes and sizes such as a plurality of cross bars defines a plurality of openings in gully covers. The cover can also have a round, rectangular, square iron shape with different weights. The removable iron cover is constructed and dimensioned to fit within the fixed iron frame to close the opening. In addition a U-shaped shackle including two arms and a bolt extending between said arms to fix the U-shaped shackle to the cover are provided. A second shackle fixed to the other of said frame or said cover and a relatively short iron chain is fixed to the U-shaped shackle and the second shackle with sufficient length to permit the cover to be removed from the frame but insufficient length to permit the cover to be removed from the immediate area. In the preferred embodiment of the invention the cover, fixed iron frame, chain and U-shaped shackles have a galvanized coating to prevent rust and thereby provide a durable, long lasting and almost maintenance free product. In addition, in a preferred embodiment of the invention, the chain is made of case hardened steel.

The invention will now be described in connection with the accompanying drawings wherein like reference numbers have been used to indicate like parts.

### DESCRIPTION OF THE DRAWINGS

FIG. 1 is a top or plane view of a removable gully cover in accordance with one embodiment of the invention;

FIG. 2 is a cross-sectional view taken along the line AA in FIG. 1;

FIG. 3 is a cross-sectional view of a pair of shackles and chain for fixing the cover to a frame;

FIG. 4 is a cross-sectional view of a fixed mounting frame and manhole cover in accordance with one embodiment of the present invention;

FIG. 5 is a cross-sectional view illustrating a further embodiment of the invention wherein a shackle is attached to a frame in a different manner; and

FIG. 6 is a cross-sectional view that illustrates a still further embodiment of the invention wherein a shackle is attached to the cover in a different manner.

### DESCRIPTION OF THE PREFERRED EMBODIMENTS OF THE INVENTION

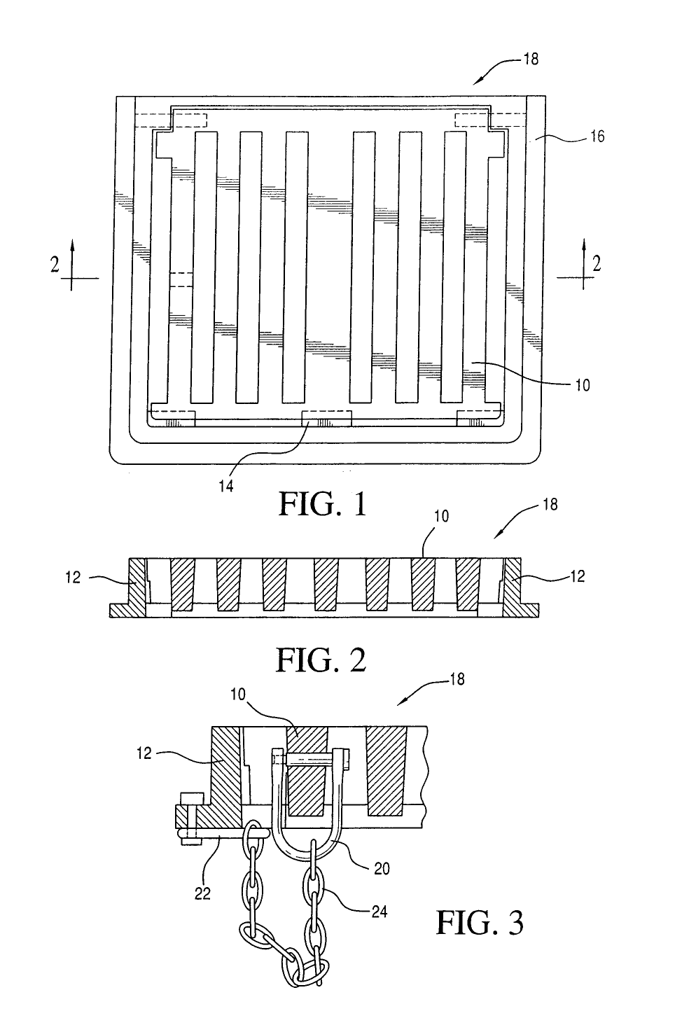

A removable cover 18 for a manhole, drain, accessible opening or the like with an anti-theft device for preventing the theft of such covers will now be described in connection with FIGS. 1-6. As shown in FIGS. 1 and 2 the cover 10 includes an iron mounting frame 12 that extends around the manhole 18 and is preferably embedded in a mass of concrete. The frame 12 also includes a plurality of galvanized steel anchor bolts 14 that are embedded in the concrete that forms a part of a roadway or the like in which the manhole is disposed.

The frame 12 is made of hot dipped heavily zinc coated iron i.e. medium carbon steel (from 0.30 to 0.45% by wgt. Carbon) with zinc of not less than 260 g/m² i.e. a thickness of from 75 to 120 microns. In one embodiment of the invention, the frame 12, like the cover 10 has a generally rectangular shape and includes an inwardly directed flange 14 upon which the cover 10 rest when in a closed position.

The cover 10 includes an outer rim 16 and a plurality of parallel cross members that extend from one side of the rim 16 to the opposite side thereof and defines a plurality of openings there between. The rim 16 has a thickness of about 20 mm while the cross member 18 has a thickness of about 10 mm. The rim 16 and cross members 18 are each made of medium carbon steel from about 0.30% by wgt. to about 0.45% by wgt. carbon and has a zinc coating of about 75 to 120 microns.

A pair of shackles 20 and 22 and a chain 24 fasten the cover 10 to the frame 12. The shackles 20 and 22 at least one of which is a U-shaped shackle having a pair of arms and a bolt connecting the free ends of the U-shaped arms. The chain 24 and each of the shackles 20 and 22 are made of medium carbon steel (0.30% by wgt. to 0.45% by wgt. carbon) that has been hot dipped to provide a coating of zinc having a thickness of from 75 to 120 microns. The chain has a working load of more than seven tons and a length of at least about 400 cm.

A first of the shackles 20 has a generally U-shape including a pair of arms with an open end. This open end is closed by a cross bolt shown more clearly in FIG. 3 that shows the bolt passing through one of the parallel cross members. The second shackle 22 may also be a generally U-shaped shackle wherein the ends of the arms are bolted to the frame. The second shackle 22 may have other forms such as an eye bolt or the like some of which will be described hereinafter. It is also believed that the shackles should have a diameter of at least 16 mm.

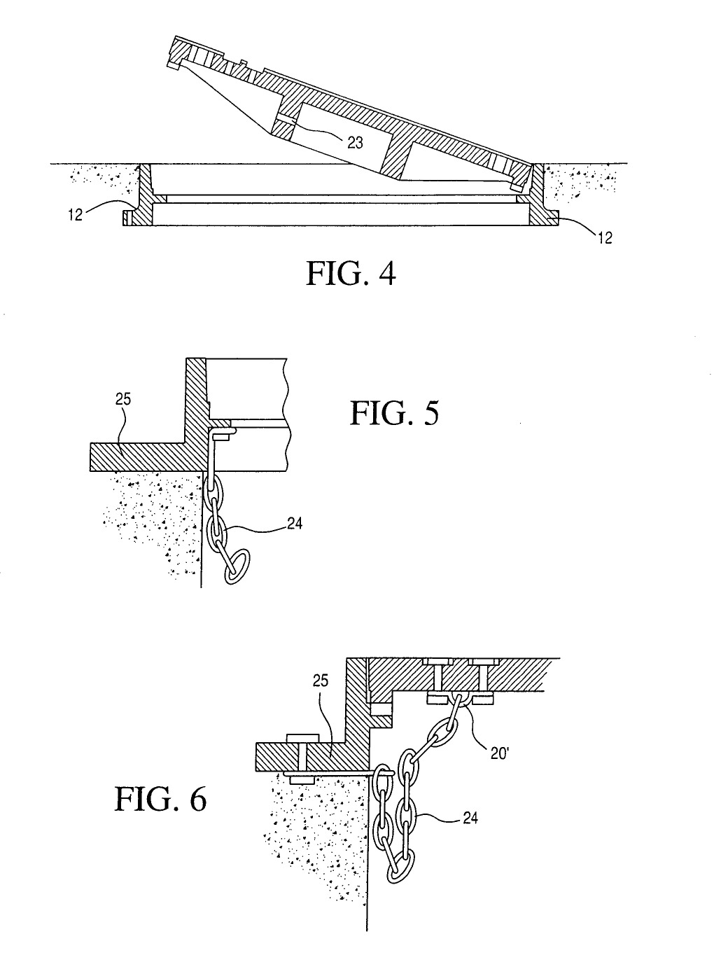

As illustrated in FIG. 4 a fixed frame and removable cover in accordance with one embodiment of the invention are shown. The cover includes a plurality of cross members one of which has a hole 23 therethrough for receiving a bolt that extends between the end portions of each arm of the shackle and is used to fasten the shackle to the cover.

FIG. 5 shows a third embodiment of the invention wherein the fixed frame 25 has an inner projection for clamping a modified U-shaped shackle to the fixed frame while FIG. 6 illustrates a different means of attaching a modified U-shaped shackle to the cover.

FIG. 6 shows a further embodiment of the invention when a shackle 20 is attached in a different manner.

While the invention has been described in connection with its preferred embodiments it should be recognized that changes and modifications may be made therein without departing from the scope of the appended claims.

1. (canceled)

2. (canceled)

3. (canceled)

4. (canceled)

5. (canceled)

6. (canceled)

7. In combination, a removable cover for a manhole and an anti-theft device for preventing unauthorized removal of said removable cover, comprising:
a fixed iron frame having a peripheral flange with an upper surface and a lower surface and securely bounding an access opening to said manhole, and said fixed iron frame being embedded within a mass of concrete on the ground;
said removable cover having an outer rim and a plurality of cross bars defining a plurality of alternating openings in said removable cover, wherein said removable cover is configured and dimensioned to pivotally mount within said fixed iron frame at one end, one of said plurality of cross bars having a bolt-receiving bore therethrough;
said anti-theft device comprising a first U-shaped shackle bounding said cross bar having a bolt-receiving bore therethrough and removably secured thereto with a bolt;
a second shackle having a first end and a second end, said first end secured to said lower surface of said peripheral flange and said second end extending at a clearance distance from said peripheral flange;
a chain having a plurality of links attached to said U-shaped shackle at one end, and attached to said second shackle second end at an opposing end, and having sufficient length to permit said removable cover to pivotally raise above from said fixed iron frame; and,
said removable cover, said fixed iron frame, and said chain have a galvanized coating thereon.

8. (canceled)

9. The combination of claim 7, wherein said fixed iron frame and said removable cover each has a substantially rectangular shape.
